(19) United States
(12) Patent Application Publication
(10) Pub. No.: US 2026/0127071 A1
(43) Pub. Date: May 7, 2026

(54) FAST DECODING OF REED-SOLOMON CODES

(71) Applicant: Micron Technology, Inc., Boise, ID (US)

(72) Inventor: Phong Sy Nguyen, Livermore, CA (US)

(21) Appl. No.: 19/368,282

(22) Filed: Oct. 24, 2025

Related U.S. Application Data
(60) Provisional application No. 63/717,156, filed on Nov. 6, 2024.

(51) Int. Cl. G06F 11/10

(52) U.S. Cl. CPC G06F 11/1048; G06F 11/1016; G06F 11/1068

(57) ABSTRACT

An example method of fast decoding of Reed-Solomon codes in memory sub-systems includes: receiving encoded data comprising a distorted encoded codeword, wherein the distorted encoded codeword comprises up to a maximum number of correctable errors; calculating a plurality of syndromes associated with the distorted encoded codeword; constructing an error locator polynomial associated with the distorted encoded codeword; determining, using a direct computational scheme, one or more roots of the error locator polynomial, wherein a number of inversion operations implemented by the direct computational scheme is defined by the maximum number of correctable errors; determining, using the one or more roots of the error locator polynomial, one or more error magnitude values associated with the distorted encoded codeword; and restoring, using the one or more error magnitude values, an original codeword corresponding to the distorted encoded codeword.

### REFERENCE TO RELATED APPLICATIONS

This application claims the priority benefit of U.S. Provisional Patent Application No. 63/717,156, filed Nov. 6, 2024, the entirety of which is incorporated herein by reference.

### TECHNICAL FIELD

Implementations of the disclosure relate generally to memory sub-systems, and more specifically, relate to fast decoding of Reed-Solomon codes in memory sub-systems.

### BACKGROUND

A memory sub-system may include one or more memory devices that store data. The memory devices may be, for example, non-volatile memory devices and volatile memory devices. In general, a host system may utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various implementations of the disclosure. The drawings, however, should not be taken to limit the disclosure to the specific implementations, but are for explanation and understanding only.

FIG. 1 illustrates an example computing system that includes a memory sub-system in accordance with aspects of the present disclosure.

FIG. 2A schematically illustrates the RS decoding flow for the maximum number of correctable errors t=3, in accordance with aspects of the present disclosure.

FIG. 2B schematically illustrates the RS decoding flow for the maximum number of correctable errors t=2, in accordance with aspects of the present disclosure.

FIG. 3A schematically illustrates the detailed RS decoding flow for the maximum number of correctable errors t=3, in accordance with aspects of the present disclosure.

FIG. 3B schematically illustrates the detailed RS decoding flow for the maximum number of correctable errors t=2, in accordance with aspects of the present disclosure.

FIG. 4 is a high-level flow diagram of an example method 400 of decoding encoded codewords by a memory sub-system controller operating in accordance with aspects of the present disclosure.

FIG. 5 is a block diagram of an example computer system in which implementations of the present disclosure may operate.

### DETAILED DESCRIPTION

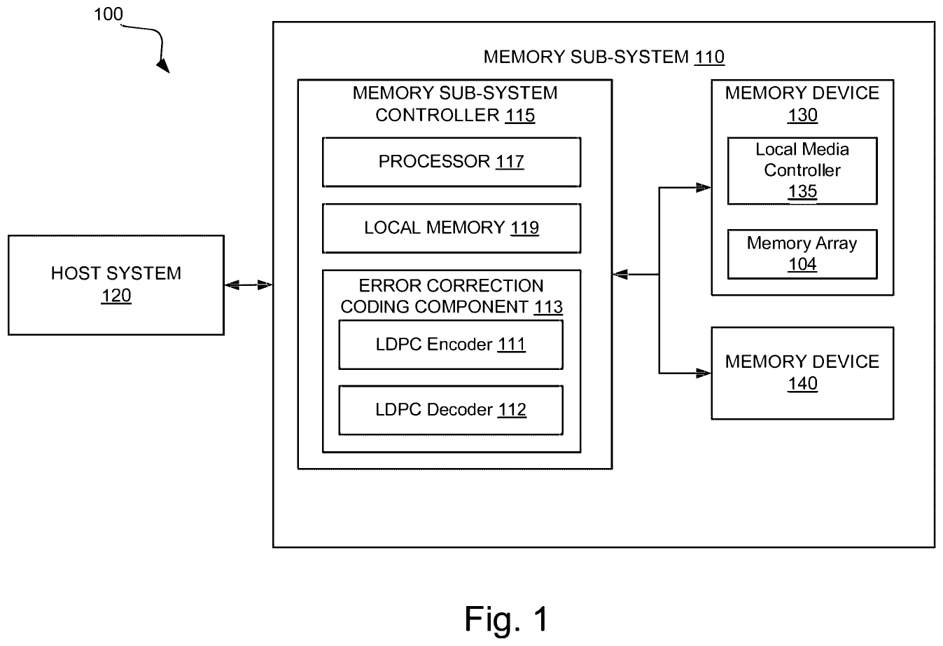

Aspects of the present disclosure are related to fast decoding of Reed-Solomon codes in memory sub-systems. A memory sub-system may be a storage device, a memory module, or a combination of a storage device and memory module. Examples of storage devices and memory modules are described below in conjunction with FIG. 1. In general, a host system may utilize a memory sub-system that includes one or more components, such as memory devices that store data. The host system may provide data to be stored at the memory sub-system and may request data to be retrieved from the memory sub-system.

A memory sub-system may utilize one or more memory devices, including any combination of the different types of non-volatile memory devices and/or volatile memory devices, to store the data provided by the host system. In some implementations, a memory sub-system may be represented by a solid-state drive (SSD), which may include one or more non-volatile memory devices. In some implementations, the non-volatile memory devices may be provided by negative-and (NAND) type flash memory devices. Other examples of non-volatile memory devices are described below in conjunction with FIG. 1. A non-volatile memory device is a package of one or more dice. Each die may include one or more planes. A plane is a portion of a memory device that includes multiple memory cells. Some memory devices may include two or more planes. For some types of non-volatile memory devices (e.g., NAND devices), each plane includes a set of physical blocks. Each block includes a set of pages. “Block” herein shall refer to a set of contiguous or non-contiguous memory pages. A “block” may refer to a unit of the memory device used to store data and may include a group of memory cells. An example of a “block” is an “erasable block,” which is the minimal erasable unit of memory, while “page” is a minimal writable unit of memory. Each page includes a set of memory cells. A memory cell is an electronic circuit that stores information.

A memory device may include multiple memory cells arranged in a two-dimensional grid. The memory cells are formed onto a silicon wafer in an array of columns and rows. A memory cell includes a capacitor that holds an electric charge and a transistor that acts as a switch controlling access to the capacitor. Accordingly, the memory cell may be programmed (written to) by applying a certain voltage, which results in an electric charge being held by the capacitor. The memory cells are joined by wordlines, which are conducting lines electrically connected to the control gates of the memory cells, and bitlines, which are conducting lines electrically connected to the drain electrodes of the memory cells.

Depending on the cell type, each memory cell may store one or more bits of binary information and has various logic states that correlate to the number of bits being stored. The logic states may be represented by binary values, such as “0” and “1”, or combinations of such values. A memory cell may be programmed (written to) by applying a certain voltage to the memory cell, which results in an electric charge being held by the memory cell, thus allowing modulation of the voltage distributions produced by the memory cell. A set of memory cells referred to as a memory page may be programmed together in a single operation, e.g., by selecting consecutive bitlines.

Precisely controlling the amount of the electric charge stored by the memory cell allows establishing multiple logical levels, thus effectively allowing a single memory cell to store multiple bits of information. A read operation may be performed by comparing the measured threshold voltages (Vt) exhibited by the memory cell to one or more reference voltage levels in order to distinguish between two logical levels for single-level cell (SLCs) and between multiple logical levels for multi-level cells. Each logical level may be translated into a corresponding binary representation of the content of the memory cell. In an illustrative example, a Gray code may be employed for translating the cell charge levels (voltage levels) into their respective binary representations and vice versa. A Gray code refers to an encoding in which adjacent numbers have a single digit different by one.

Memory access operations (e.g., a read operation, a programming (write) operation, an erase operation, etc.) may be executed with respect to sets of the memory cells, e.g., in response to receiving memory access commands from the host. A memory access operation may specify the requested memory access operation (e.g., write, erase, read, etc.) and a logical address, which the memory sub-system would translate to a physical address identifying a set of memory cells (e.g., a block).

In order to improve endurance of a memory device, the data to be written to the memory device may be modulated to achieve a desired distribution of the charge levels in the memory cells addressable by a given wordline and, in some implementations, also in the memory cells addressable by neighboring wordlines of the given wordline. For example, a random data pattern encoded by a Gray code would result in uniform distribution of the memory cell charge levels (such that the number of memory cells at an arbitrary chosen charge level being roughly equal to the number of memory cells at any other charge level).

The modulated data may be encoded prior to being stored on a memory device, and thus would need to be decoded when later retrieved from the memory sub-system. For example, a sequence of symbols (e.g., representing one or more bits of binary information), may be transformed by an encoder to generate a codeword, which may then be stored on a memory device. However, in some cases, the sensed data read back from the memory device may differ from the original encoded data, e.g., on account of errors (e.g., bit-flip errors) that may have occurred during storage and/or retrieval of the encoded data to/from the memory device. Thus, the sensed data may include one or more distorted encoded codewords, each of which may contain one or more errors.

In some implementations, the data may be encoded using an error correcting code (ECC), which produces encoded data that includes redundant information allowing the original data to be recovered even if some errors have been introduced during the data storage and/or retrieval. Accordingly, the transformation employed by the encoder may be chosen such that the errors (e.g., bit flips that may occur when storing and/or retrieving the codeword) may be detected and corrected when the codeword is later retrieved from the memory device and decoded by a decoder.

Should the decoder fail to correct one or more errors in the distorted codeword retrieved from the memory device, the memory sub-system may perform a read error handling sequence in an attempt to recover the data. The read error handling sequence may include one or more read error handling operations. An error handling operation, for example, may include one or more read retries using different parameters, such as the read voltage, as compared to the previous read operation performed on the memory cell. In some implementations, read voltage level adjustments may be performed based on values of one or more data state metrics obtained from a sequence of read and/or write operations. In an illustrative example, the data state metric may be represented by a raw bit error rate (RBER), which refers to the error rate in terms of a measure of bits that contain incorrect data (i.e., bits that were sensed erroneously) when a data access operation is performed on a memory device (e.g., the ratio of the number of erroneous bits to the number of all data bits stored in a certain portion, such as a specified block, of the memory device).

One example of ECCs that may be used by a memory sub-system controller are Reed-Solomon (RS) codes. RS encoding involves splitting the original data into symbol sequences of a pre-defined size (e.g., k symbols) and appending (n-k) symbols of error correction metadata (“parity symbols”) to each bit sequence, thus forming an n-symbol codeword to be stored on the memory device. An RS code having (n-k) parity symbols may correct up to s<=t=(n-k)/2 symbol errors. The parameter t, denoting the maximum number of errors that are correctable by the code, is called the correction capability of the code.

RS codes operate in a finite field, e.g., Galois field GF(2^{m}), where m is the symbol size in bits. In an illustrative example, m=8 (8-bit symbols). In another illustrative example, m=4 (4-bit symbols).

Accordingly, a codeword, which is an encoded representation of the original symbol sequence of a pre-defined size (e.g., k symbols), is a sequence of n symbols of the chosen finite field (c₀, c₁, . . . , cₙ₋₁) where cᵢ∈GF(2^{m}), which in turn may be represented in a polynomial form:

$$c ( x ) = {\sum }_{i = 0}^{n - 1} {c}_{i} {x}^{i}$$

The codeword may be transmitted through a communication channel (e.g., stored on a memory device). The corresponding received vector representing the distorted codeword is the sequence of n symbols, which is received from the communication channel (e.g., retrieved from the memory device). The received (e.g., read from the memory device) vector (r₀, r₁, . . . , rₙ₋₁) where r₁∈GF(2^{m}) may also be represented in a polynomial form:

$$r ( x ) = {\sum }_{i = 0}^{n - 1} {r}_{i} {x}^{i}$$

As the decoder can decode a distorted codeword containing up to s<=t=(n-k)/2 symbol errors introduced by the communication channel, the received polynomial corresponding to the received vector may be represented as the sum of the codeword polynomial and the error polynomial:

r(x)=c(x)+e(x) where e

$$e ( x ) = {\sum }_{i = 0}^{n - 1} {e}_{i} {x}^{i}$$

is the error polynomial based on the error vector (e₀, e₁, . . . , eₙ₋₁).

Assuming that the received vector contains s errors at locations i₀, . . . , iₛ₋₁∈{0, . . . , n−1}, the error vector may be represented by the following error polynomial:

$$e ( x ) = {\sum }_{ℓ = 0}^{s - 1} {e}_{{i}_{ℓ}} {x}^{{i}_{ℓ}} = {\sum }_{ℓ = 0}^{s - 1} {E}_{ℓ} {x}^{{i}_{ℓ}}$$

where [symbol] = [symbol] denotes the corresponding non-zero error magnitude.

Decoding the received vector r(x) may involve calculating the syndromes, deriving the error locator polynomial, determining the roots of the error locator polynomial, calculating the error magnitudes, and restoring the original codeword.

The syndromes are the values of the received polynomial (reconstructed from the received vector) at specific points, i.e., the roots of the generator polynomial used in the encoding process. If all syndrome values are zero, no errors are present in the received vector, and thus the received vector is the original codeword. If any syndrome value is non-zero, the received vector contains one or more errors. In the latter case, the syndromes may be used to construct the error locator polynomial, which identifies the positions of the errors within the received vector. Once the error locations are known, the magnitude of the errors at these positions may be determined. Finally, the errors are corrected by adjusting the received distorted codeword using the error magnitudes and locations, thus restoring the original codeword.

The degree of the error locator polynomial does not exceed the maximum number t of correctable errors (e.g., three). In some implementations, the roots of the error locator polynomial may be determined by a set of predefined formulas (e.g., for the second and third degree polynomials). The formulas that are utilized for computations may be optimized for efficiency, such that the critical path would contain no more than a predefined number of division (inversion) operations, which are the most computationally complex arithmetic operations in finite fields.

Accordingly, aspects of the present disclosure improve the efficiency of memory access operations by implementing an RS decoder that utilizes predefined formulas for deriving the error locator polynomial, determining the roots of the error locator polynomial, calculating the error magnitudes, as described in more detail herein below.

Various aspects of the methods and systems are described herein by way of examples, rather than by way of limitation. The systems and methods described herein may be implemented by hardware (e.g., general purpose and/or specialized processing devices, and/or other devices and associated circuitry), software (e.g., instructions executable by a processing device), or a combination thereof.

FIG. 1 illustrates an example computing system 100 that includes a memory sub-system 110 in accordance with some implementations of the present disclosure. The memory sub-system 110 may include media, such as one or more volatile memory devices (e.g., memory device 140), one or more non-volatile memory devices (e.g., memory device 130), or a combination of such.

A memory sub-system 110 may be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 may include a host system 120 that is coupled to one or more memory sub-systems 110. In some implementations, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which may be an indirect communicative connection or direct communicative connection (e.g., without intervening components), whether wired or wireless, including connections such as electrical, optical, magnetic, etc.

The host system 120 may include a processor chipset and a software stack executed by the processor chipset. The processor chipset may include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 may be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface may be used to transmit data between the host system 120 and the memory sub-system 110. The host system 120 may further utilize an NVM Express (NVMe) interface to access components (e.g., memory devices 130) when the memory sub-system 110 is coupled with the host system 120 by the physical host interface (e.g., PCIe bus). The physical host interface may provide an interface for passing control, address, data, and other signals between the memory sub-system 110 and the host system 120. FIG. 1 illustrates a memory sub-system 110 as an example. In general, the host system 120 may access multiple memory sub-systems via a same communication connection, multiple separate communication connections, and/or a combination of communication connections.

The memory devices 130, 140 may include any combination of the different types of non-volatile memory devices and/or volatile memory devices. The volatile memory devices (e.g., memory device 140) may be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells may perform bit storage based on a change of bulk resistance, in conjunction with a stackable cross-gridded data access array. Additionally, in contrast to many flash-based memories, cross-point non-volatile memory may perform a write in-place operation, where a non-volatile memory cell may be programmed without the non-volatile memory cell being previously erased. NAND type flash memory includes, for example, two-dimensional NAND (2D NAND) and three-dimensional NAND (3D NAND).

Each of the memory devices 130 may include one or more arrays of memory cells. One type of memory cell, for example, single level cells (SLC) may store one bit per cell. Other types of memory cells, such as multi-level cells (MLCs), triple level cells (TLCs), quad-level cells (QLCs), and penta-level cells (PLCs) may store multiple bits per cell. In some implementations, each of the memory devices 130 may include one or more arrays of memory cells such as SLCs, MLCs, TLCs, QLCs, PLCs or any combination of such. In some implementations, a particular memory device may include an SLC portion, and an MLC portion, a TLC portion, a QLC portion, or a PLC portion of memory cells. The memory cells of the memory devices 130 may be grouped as pages that may refer to a logical unit of the memory device used to store data. With some types of memory (e.g., NAND), pages may be grouped to form blocks.

Although non-volatile memory components such as a 3D cross-point array of non-volatile memory cells and NAND type flash memory (e.g., 2D NAND, 3D NAND) are described, the memory device 130 may be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) may communicate with the memory devices 130 to perform operations such as reading data, writing data, or erasing data at the memory devices 130 and other such operations. The memory sub-system controller 115 may include hardware such as one or more integrated circuits and/or discrete components, a buffer memory, or a combination thereof. The hardware may include a digital circuitry with dedicated (i.e., hard-coded) logic to perform the operations described herein. The memory sub-system controller 115 may be a microcontroller, special purpose logic circuitry (e.g., a field programmable gate array (FPGA), an application specific integrated circuit (ASIC), etc.), or other suitable processor.

The memory sub-system controller 115 may include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some implementations, the local memory 119 may include memory registers storing memory pointers, fetched data, etc. The local memory 119 may also include read-only memory (ROM) for storing micro-code. While the example memory sub-system 110 in FIG. 1 has been illustrated as including the memory sub-system controller 115, in another implementation of the present disclosure, a memory sub-system 110 does not include a memory sub-system controller 115, and may instead rely upon external control (e.g., provided by an external host, or by a processor or controller separate from the memory sub-system).

In general, the memory sub-system controller 115 may receive commands or operations from the host system 120 and may convert the commands or operations into instructions or appropriate commands to achieve the desired access to the memory devices 130. The memory sub-system controller 115 may be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115, for example, may employ a Flash Translation Layer (FTL) to translate logical addresses to corresponding physical memory addresses, which may be stored in one or more FTL mapping tables. In some instances, the FTL mapping table may be referred to as a logical-to-physical (L2P) mapping table storing L2P mapping information. The memory sub-system controller 115 may further include host interface circuitry to communicate with the host system 120 via the physical host interface. The host interface circuitry may convert the commands received from the host system into command instructions to access the memory devices 130 as well as convert responses associated with the memory devices 130 into information for the host system 120.

The memory sub-system 110 may also include additional circuitry or components that are not illustrated. In some implementations, the memory sub-system 110 may include a cache or buffer (e.g., DRAM) and address circuitry (e.g., a row decoder and a column decoder) that may receive an address from the memory sub-system controller 115 and decode the address to access the memory devices 130.

In some implementations, the memory devices 130 include local media controllers 135 that operate in conjunction with memory sub-system controller 115 to execute operations on one or more memory cells of the memory devices 130. An external controller (e.g., memory sub-system controller 115) may externally manage the memory device 130 (e.g., perform media management operations on the memory device 130). In some implementations, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

As noted above, memory sub-system 110 may include an error correction coding component 113 that may be used to encode data for storage on a memory device and decode encoded data when retrieved from a memory device. In some implementations, memory sub-system 110 (e.g., memory sub-system control 115) may receive data from host system 120 along with a command to store the host data. The host data received from host system 120 may be or include a stream of one or more data symbols (e.g., representing one or more bits of binary information). In some cases, for example, the host data may be or include a stream of binary data bits (e.g., a stream of 0's and 1's). Memory sub-system 110 (e.g., memory sub-system controller 115) may provide the host data to error correction coding component 113 and instruct error correction coding component 113 to generate encoded host data (or encoded data) therefrom.

In some implementations, error correction coding component 113 may use an error correcting code (ECC), such as a Reed-Solomon (RS) code, to encode data in such a way (e.g., by including redundant information) so as to allow errors, which may be introduced (e.g., during storage and/or retrieval of the encoded data to/from a memory device), to be detected and corrected when later decoded. In some implementations, error correction coding component 113 may include an RS encoder 111 that error correction coding component 113 may use to encode host data using an RS code. In some implementations, error correction coding component 113 may process host data using an RS code and generate one or more codewords therefrom. Error correction coding component 113, for instance, may use the RS encoder 111 to process a sequence of one or more symbols of host data and generate an encoded codeword therefrom. Error correction coding component 113, for example, may use the RS encoder 111 to process k symbols of host data to generate encoded codewords of length n therefrom, which may contain k symbols of host data and n-k symbols of redundancy data.

RS encoding involves splitting the original data into symbol sequences of a pre-defined size (e.g., k symbols) and appending (n-k) symbols of error correction metadata (“parity symbols”) to each bit sequence, thus forming an n-symbol encoded codeword to be stored on the memory device. An RS code having (n-k) parity symbols may correct up to s<=t=(n-k)/2 symbol errors, where t is the correction capability of the code (i.e., the maximum number of correctable errors).

RS codes operate in a finite field, e.g., Galois field GF(2^{m}), where m is the symbol size in bits. In an illustrative example, m=8 (8-bit symbols). In another illustrative example, m=4 (4-bit symbols).

Accordingly, an encoded codeword, which is an encoded representation of the original symbol sequence of a pre-defined size (e.g., k symbols), is a sequence of n symbols of the chosen finite field (c₀, c₁, . . . , cₙ₋₁) where cᵢ∈GF(2^{m}), which in turn may be represented in a polynomial form:

$$c ( x ) = {\sum }_{i = 0}^{n - 1} {c}_{i} {x}^{i}$$

The encoded codeword may be transmitted through a communication channel (e.g., stored on a memory device). In some implementations, the encoded data generated by error correction coding component 113 may be returned to memory sub-system 110 (e.g., to memory sub-system controller 115), which may store one or more encoded codewords on a memory device 130. In some implementations, memory sub-system 110 may perform a write operation to write the encoded codewords to a memory device (e.g., at an identified storage location therein). In some implementations, encoded data may be returned to memory sub-system 110 and written to a memory device as the encoded data is generated (e.g., as each encoded codeword is generated). In some implementations, the encoded data may be returned to and/or written by memory sub-system 110 after all host data in a host data storage request has been encoded.

As noted above, ECC component 113 may also be used to decode the encoded data when it is retrieved from a memory device. For example, in some implementations, memory sub-system 110 (e.g., memory sub-system controller 115) may receive a request from host system 120 to retrieve host data that was previously encoded and stored at memory sub-system 110 (e.g., in response to an earlier storage request). In response to the request, memory sub-system 110 may determine where encoded data corresponding to the requested host data is stored (e.g., using an FTL mapping table maintained by memory sub-system 110) and may perform a read operation to read the encoded data back from a memory device. In some implementations, memory sub-system 110 may read encoded data back from memory device 130 as part of a read operation by performing one or more sense operations to determine a value of the memory cells that store the encoded data. The encoded data read back from the memory device (or sensed data) may include one or more sensed (possibly distorted) codewords.

Memory sub-system 110 may provide the sensed data returned by a read operation to ECC component 113 and instruct ECC component 113 to decode the sensed data and obtain the host data encoded therein. In some instances, the sensed data read back from the memory device may differ from the initial encoded data that was first generated, for example, on account of errors (e.g., bit-flip errors) that may have occurred during storage and/or retrieval of the encoded data to/from the memory device. The sensed data, however, may be encoded using an ECC, such as an RS code, which may allow ECC component 113 to detect and correct errors in the sensed data and restore initial host data encoded therein.

In some implementations, ECC component 113 may include an RS decoder 112 that ECC component 113 may use to decode sensed data encoded using an RS code. In some implementations, ECC component 113 may use RS decoder 112 to process sensed data and obtain one or more sequences of host data encoded therein. In processing the sensed data, RS decoder 112 may detect and attempt to correct any errors therein.

As noted herein above, an encoded codeword may be transmitted through a communication channel (e.g., stored on a memory device). The corresponding received vector is the sequence of n symbols, which is received from the communication channel (e.g., retrieved from the memory device). The received (e.g., read from the memory device) vector (r₀, r₁, . . . , rₙ₋₁) where rᵢ∈GF(2^{m}) may be represented in a polynomial form:

$$r ( x ) = {\sum }_{i = 0}^{n - 1} {r}_{i} {x}^{i}$$

As the communication channel (e.g., the process of storing and retrieving the codeword from a memory device) may introduce s<=t=(n-k)/2 symbol errors, the received polynomial may be represented as the sum of the codeword polynomial and the error polynomial:

r(x) c(x)+e(x) where

$$e ( x ) = {\sum }_{i = 0}^{n - 1} {e}_{i} {x}^{i}$$

is the error polynomial based on the error vector (e₀, e₁, . . . , eₙ₋₁).

Assuming that the received vector contains s errors at locations i₀, . . . , iₛ₋₁∈{0, . . . , n−1}, the error vector may be represented by the following error polynomial:

$$e ( x ) = {\sum }_{ℓ = 0}^{s - 1} {e}_{{i}_{ℓ}} {x}^{{i}_{ℓ}} = {\sum }_{ℓ = 0}^{s - 1} {E}_{ℓ} {x}^{{i}_{ℓ}}$$

where [symbol] = [symbol] denotes the corresponding non-zero error magnitude.

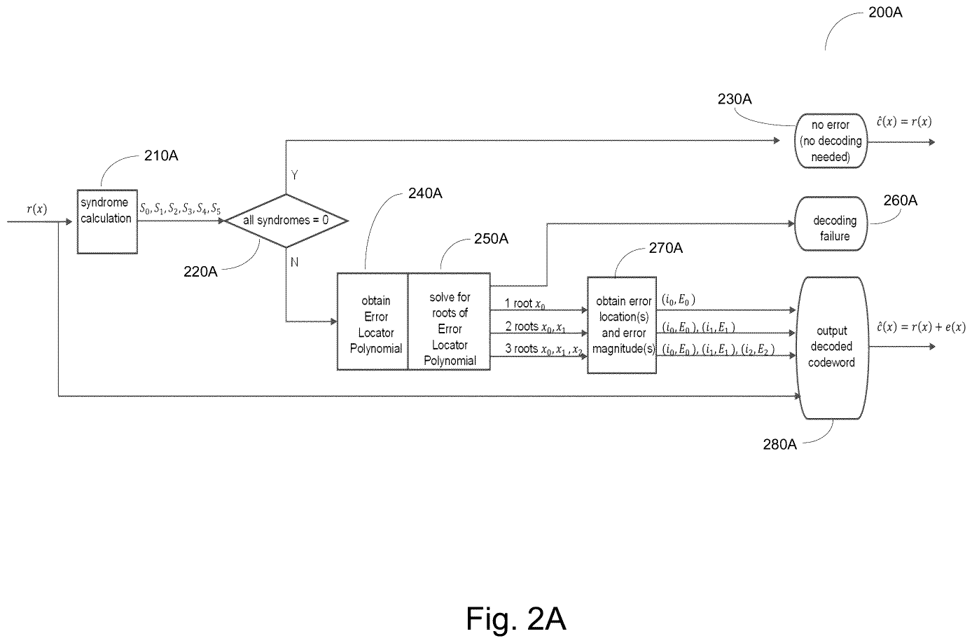

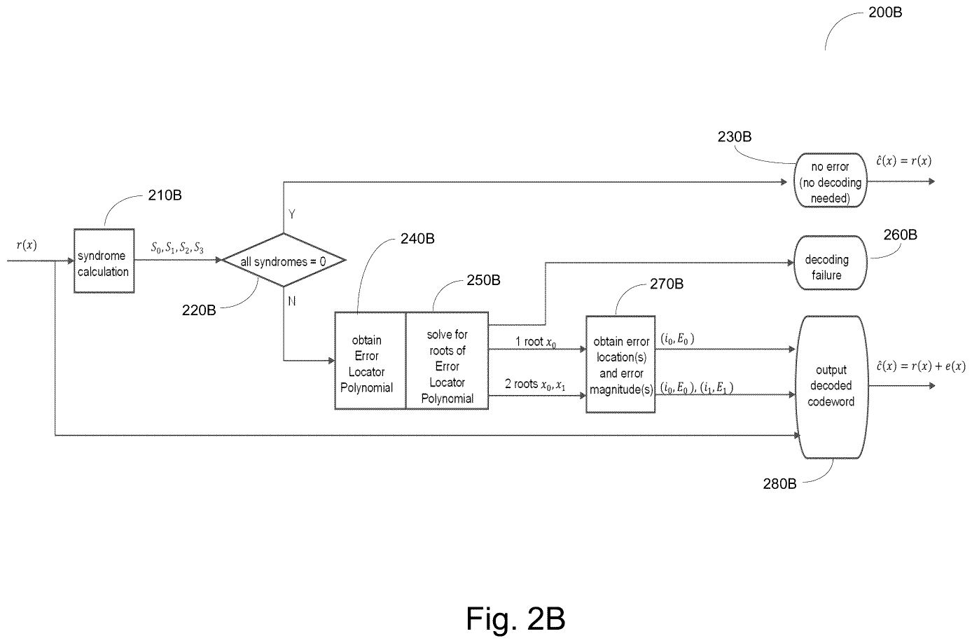

FIGS. 2A-2B schematically illustrate RS decoding flows implemented in accordance with aspects of the present disclosure. In particular, FIG. 2A schematically illustrates the RS decoding flow for the maximum number of correctable errors t=3 and FIG. 2B schematically illustrates the RS decoding flow for the maximum number of correctable errors t=2.

As illustrated by FIGS. 2A-2B, decoding the received vector r(x) may involve calculating the syndromes (operations 210A, 210B), deriving the error locator polynomial (operations 240A, 240B), determining the roots of the error locator polynomial (operations 250A, 250B), calculating the error magnitudes (operations 270A, 270B), and restoring the codeword (operations 280A, 280B).

The syndromes are the values of the received polynomial (reconstructed from the received vector) at specific points, i.e., the roots of the generator polynomial used in the encoding process. Specifically, for an RS code operating in the Galois field GF(2^{m}), the syndromes may be computed (operations 210A, 210B) using the following formula:

$${S}_{j} = r ( {α}^{j} ) for j = 0 , 1 , … , 2 t - 1$$

where Sⱼ is the j-th syndrome, and
α is the primitive element of GF(2^{m}), such that every non-zero β∈GF(2^{m}) may be expressed as β=α^{j} for some 0≤j≤2^{m}−2.

If all syndrome values are zero (comparison operations 220A, 220B), no errors are present in the received vector, and thus the received vector is the original codeword (output operations 230A, 230B). If any syndrome value is non-zero, the received vector contains one or more errors, and the syndromes may be used to construct the error locator polynomial (operations 240A, 240B), which identifies the positions of the errors within the received vector.

In particular, for the maximum number of correctable errors t=3, six syndromes may be calculated (operation 210A): S₀, S₁, S₂, S₃, S₄, and S₅. The error locator polynomial may be defined by the following formula:

$$λ ( x ) = {λ}_{0} ( 1 - {X}_{0} x ) ( 1 - {X}_{1} x ) ( 1 - {X}_{2} x ) = {λ}_{0} + {λ}_{1} x + {λ}_{2} {x}^{2} + {λ}_{3} {x}^{3}$$

$$where {λ}_{0} \neq 0 and {X}_{ℓ} = {α}^{{i}_{ℓ}} ,$$

and
where [symbol] is an error position in the received vector, [symbol] ∈{0,1, . . . , n−1}, [symbol] =0,1,2.

The coefficients of the error locator polynomial can be derived (operation 240A) as follows:

$$\begin{matrix}{λ}_{0} = {S}_{2} {R}_{2} + {S}_{3} {R}_{1} + {S}_{4} {R}_{0} \\ {λ}_{1} = {S}_{3} {R}_{2} + {S}_{4} {R}_{1} + {S}_{5} {R}_{0} \\ {λ}_{2} = {S}_{4} {R}_{2} + {S}_{5} {R}_{1} + {S}_{2} {S}_{3}^{2} + {S}_{0} {S}_{4}^{2} \\ {λ}_{3} = {S}_{5} {R}_{2} + {S}_{3}^{3} + {S}_{1} {S}_{4}^{2}\end{matrix}$$

$$where {R}_{0} = {S}_{0} {S}_{2} + {S}_{1}^{2} , {R}_{1} = {S}_{0} {S}_{3} + {S}_{1} {S}_{2} , and {R}_{2} = {S}_{1} {S}_{3} + {S}_{2}^{2} .$$

Similarly, for the maximum number of correctable errors t=2, four syndromes may be calculated (operation 210B): S₀, S₁, S₂, and S₃. The error locator polynomial may be defined by the following formula:

$$λ ( x ) = {λ}_{0} ( 1 - {X}_{0} x ) ( 1 - {X}_{1} x ) = {λ}_{0} + {λ}_{1} x + {λ}_{2} {x}^{2}$$

$$where {λ}_{0} \neq 0 and {X}_{ℓ} = {α}^{{i}_{ℓ}} ,$$

and
where [symbol] is an error position in the received vector, iₗ∈{0,1, . . . , n−1}, [symbol] =0,1,2.

The coefficients of the error locator polynomial can be derived (operation 240B) as follows:

$$\begin{matrix}{λ}_{0} = {R}_{0} \\ {λ}_{1} = {R}_{1} \\ {λ}_{2} = {R}_{2}\end{matrix}$$

$$where {R}_{0} = {S}_{0} {S}_{2} + {S}_{1}^{2} , {R}_{1} = {S}_{0} {S}_{3} + {S}_{1} {S}_{2} , and {R}_{2} = {S}_{1} {S}_{3} + {S}_{2}^{2} .$$

If there is only one correctable error, the error locator polynomial may be defined by the following formula:

$$λ ( x ) = {λ}_{0} ( 1 - {X}_{0} x ) = {λ}_{0} + {λ}_{1} x$$

$$where {λ}_{0} \neq 0 and {X}_{0} = {α}^{- {i}_{0}} ,$$

and
where i₀ is an error location in the received vector, [symbol] ∈{0,1, . . . , n−1}, [symbol] =0,1,2.

The coefficients of the error locator polynomial can be derived (operation 240B) as follows:

$$\begin{matrix}{λ}_{0} = {R}_{0} \\ {λ}_{1} = {R}_{1}\end{matrix}$$

$$where {R}_{0} = {S}_{0} {S}_{2} + {S}_{1}^{2} and {R}_{1} = {S}_{0} {S}_{3} + {S}_{1} {S}_{2} .$$

Once the error locations are known, the magnitude of the errors at these positions may be determined, and the original codeword may be restored based on the received distorted codeword and the computed error magnitudes, as described in more detail herein below.

Responsive to successfully decoding the codeword, the decoded codeword may be returned to the host. Conversely, should the decoding flow terminate with a failure, the next stage of the read error handling sequence may be initiated. In some implementations, the next stage of the read error handling sequence may be performed using different read operation parameters, such as the read voltage, as compared to the previous stage. In some implementations, read voltage level adjustments may be performed based on values of one or more data state metrics (e.g., RBER) obtained from a sequence of read and/or write operations.

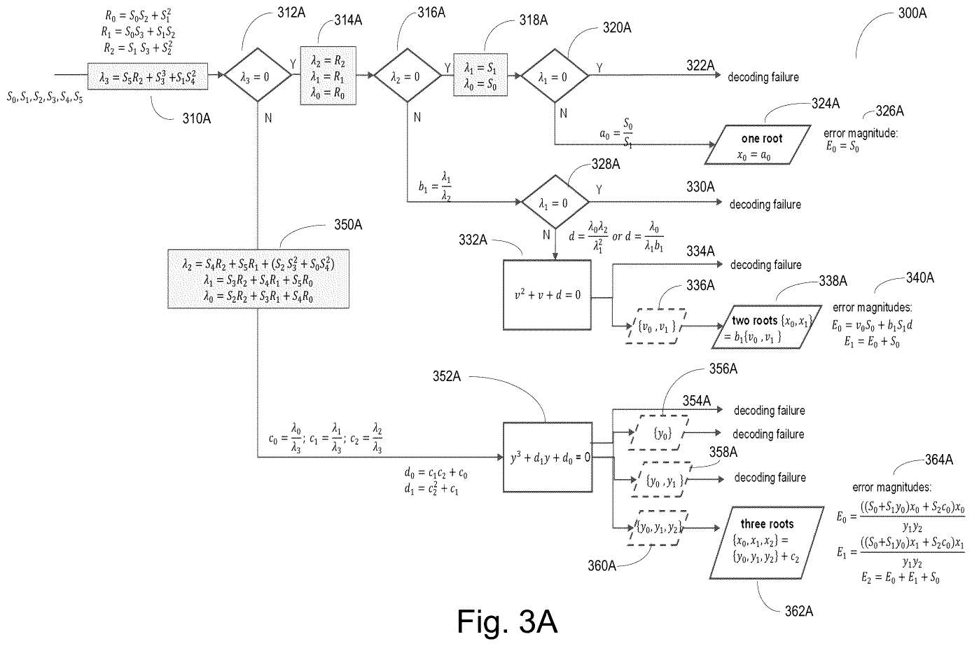

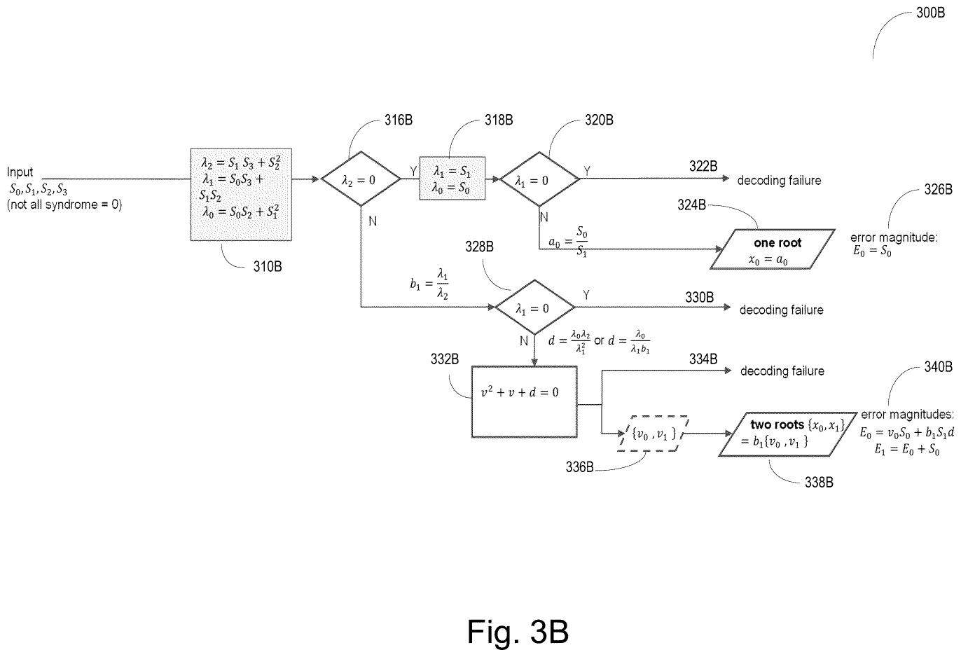

FIGS. 3A-3B schematically illustrate detailed RS decoding flows implemented in accordance with aspects of the present disclosure. The decoding flows 300A-300B may be performed by processing logic that may include hardware (e.g., general purpose or specialized processing devices, circuitry, dedicated logic, programmable logic, microcode, integrated circuits, etc.), software (e.g., instructions run or executed on a processing device), or various combinations thereof. In some implementations, a decoding flow 300A-300B may be performed by a single processing thread. Alternatively, aa decoding flow 300A-300B may be performed by two or more processing threads, each thread executing one or more individual functions, routines, subroutines, or operations of the method. In an illustrative example, the processing threads implementing a decoding flow 300A-300B may be synchronized (e.g., using semaphores, critical sections, and/or other thread synchronization mechanisms). Alternatively, the processing threads implementing a decoding flow 300A-300B may be executed asynchronously with respect to each other. In some implementations, the decoding flows 300A-300B is performed by the memory system controller (e.g., ECC component 113 of FIG. 1) and/or local media controller. Operations of the decoding flows 300A-300B may be specified by a sequence of command codes, which the processing logic may retrieve from a dedicated storage location. Although shown in a particular sequence or order, unless otherwise specified, the order of the operations may be modified. Thus, the illustrated implementations should be understood only as examples, and the illustrated operations may be performed in a different order, and some operations may be performed in parallel. Additionally, one or more operations may be omitted in various implementations. Thus, not all operations are required in every implementation.

In some implementations, the decoding flows 300A-300B may be implemented by direct computational schemes (i.e., computational schemes that involve no iterative procedures).

In particular, FIG. 3A schematically illustrates the RS decoding flow for the maximum number of correctable errors t=3.

As schematically illustrated by FIG. 3A, the operation 310A computes the value of the third coefficient of the error locator polynomial, based on the received syndromes S₀ . . . S₅ and precomputed values of

$${R}_{0} = {S}_{0} {S}_{2} + {S}_{1}^{2} , {R}_{1} = {S}_{0} {S}_{3} + {S}_{1} {S}_{2} , and {R}_{2} = {S}_{1} {S}_{3} + {S}_{2}^{2}$$

as follows:

$${λ}_{3} = {S}_{5} {R}_{2} + {S}_{3}^{3} + {S}_{1} {S}_{4}^{2} .$$

Responsive to determining, at operation 312A, that the third coefficient λ₃ of the error locator polynomial is equal to zero, the computations continue at operation 314A; otherwise, the decoding flow branches to operation 350A.

At operation 314A, the remaining coefficients of the error locator polynomial are computed as follows:

$${λ}_{2} = {R}_{2} , {λ}_{1} = {R}_{1} , and {λ}_{0} = {R}_{0} .$$

Responsive to determining, at operation 316A, that the second coefficient λ₂ of the error locator polynomial is equal to zero, the computations continue at operation 318A; otherwise, the decoding flow branches to operation 328A.

At operation 318A, the remaining coefficients of the error locator polynomial are re-computed as follows:

$${λ}_{1} = {S}_{1} , and {λ}_{0} = {S}_{0} .$$

Responsive to determining, at operation 320A, that the first coefficient λ₁ of the error locator polynomial is equal to zero, a decoding failure is returned at operation 322A; otherwise, at operation 324A, the only root of the error locator polynomial is computed as follows:

$${x}_{0} = {S}_{0} / {S}_{1} .$$

Accordingly, at operation 326A, the error magnitude is computed as follows:

$${E}_{0} = {S}_{0} .$$

The computed error magnitude can be used for restoring the original codeword, as described in more detail herein below.

As noted herein above, responsive to determining, at operation 316A, that the second coefficient λ₂ of the error locator polynomial is not equal to zero, the decoding flow branches to operation 328A.

Responsive to determining, at operation 328A, that the first coefficient λ₁ of the error locator polynomial is equal to zero, a decoding failure is returned at operation 330A; otherwise, at operation 332A, a quadratic equation is solved:

$${v}_{2} + v + d = 0 ,$$

$$where d = {λ}_{0} {λ}_{2} / {λ}_{1}^{2} = {λ}_{0} / {λ}_{1} {b}_{1} and b = {λ}_{1} / {λ}_{2} .$$

If no roots of the quadratic equation are found at operation 332A, a decoding failure is returned at operation 330A; otherwise, at operation 338A, two roots of the error locator polynomial are computed as follows:

$$\{ {x}_{0} , {x}_{1} \} = {b}_{1} \{ {v}_{0} , {v}_{1} \} ,$$

where {v₀, v₁} are the roots of the quadratic equation found at operation 332A.

Accordingly, at operation 340A, the error magnitudes are computed as follows:

$${E}_{0} = {v}_{0} {S}_{0} + {b}_{1} {S}_{1} d ; and$$

$${E}_{1} = {E}_{0} + {S}_{0} .$$

The computed error magnitudes can be used for restoring the original codeword, as described in more detail herein below.

As noted herein above, responsive to determining at operation 312A, that the third coefficient Δ₃ of the error locator polynomial is not equal to zero, the decoding flow branches to operation 350A.

At operation 350A, the remaining coefficients of the error locator polynomial are re-computed as follows:

$${λ}_{2} = {S}_{4} {R}_{2} + {S}_{5} {R}_{1} + ( {S}_{2} {S}_{3}^{2} + {S}_{0} {S}_{4}^{2} )$$

$${λ}_{1} = {S}_{3} {R}_{2} + {S}_{4} {R}_{1} + {S}_{5} {R}_{0} ; and$$

$${λ}_{0} = {S}_{2} {R}_{2} + {S}_{3} {R}_{1} + {S}_{4} {R}_{0} .$$

At operation 352A, a quadratic equation is solved:

$${y}^{3} + {d}_{1} y + {d}_{0} = 0 ,$$

$$where {d}_{0} = {c}_{1} {c}_{2} + {c}_{0} ; {d}_{1} = {c}_{2}^{2} + {c}_{1} ; {c}_{0} = \frac{{λ}_{0}}{{λ}_{3}} ; {c}_{1} = \frac{{λ}_{1}}{{λ}_{3}} ; and {c}_{2} = \frac{{λ}_{2}}{{λ}_{3}} .$$

If no roots of the cubic equation are found at operation 352A, a decoding failure is returned at operation 354A; if only one root of the cubic equation is found at operation 352A, a decoding failure is returned at operation 356A; if only two roots of the cubic equation are found at operation 352A, a decoding failure is returned at operation 358A; otherwise, at operation 360A, three roots of the error locator polynomial are computed as follows:

$$\{ {x}_{0} , {x}_{1} , {x}_{2} \} = \{ {y}_{0} , {y}_{1} , {y}_{2} \} + {c}_{2} .$$

Accordingly, at operation 364A, the error magnitudes are computed as follows:

$${E}_{0} = \frac{( ( {S}_{0} + {S}_{1} {y}_{0} ) {x}_{0} + {S}_{2} {c}_{0} ) {x}_{0}}{{y}_{1} {y}_{2}} ;$$

$${E}_{1} = \frac{( ( {S}_{0} + {S}_{1} {y}_{0} ) {x}_{1} + {S}_{2} {c}_{0} ) {x}_{1}}{{y}_{1} {y}_{2}} ; and$$

$${E}_{2} = {E}_{0} + {E}_{1} + {S}_{0} .$$

The error magnitudes (e.g., computed at operations 326A, 340A, or 364A) can be used for restoring the original codeword, as follows:

$$c ( x ) = r ( x ) + e ( x )$$

$$where e ( x ) = {\sum }_{ℓ = 0}^{s - 1} {e}_{{i}_{ℓ}} {x}^{{i}_{ℓ}} = {\sum }_{ℓ = 0}^{s - 1} {E}_{ℓ} {x}^{{i}_{ℓ}} ;$$

[symbol] = [symbol] denotes the corresponding non-zero error magnitude.

Conversely, FIG. 3B schematically illustrates the RS decoding flow for the maximum number of correctable errors t=2.

As schematically illustrated by FIG. 3B, the operation 310B computes the value of coefficients of the error locator polynomial, based on the received syndromes S₀ . . . S₃, as follows:

$${λ}_{2} = {S}_{1} {S}_{3} + {S}_{2}^{2} ;$$

$${λ}_{1} = {S}_{0} {S}_{3} + {S}_{1} {S}_{2} ; and$$

$${λ}_{0} = {S}_{0} {S}_{2} + {S}_{1}^{2} .$$

Responsive to determining, at operation 316B, that the second coefficient λ₂ of the error locator polynomial is equal to zero, the computations continue at operation 318B; otherwise, the decoding flow branches to operation 328B.

At operation 318B, two coefficients of the error locator polynomial are re-computed as follows:

$${λ}_{1} = {S}_{1} , and {λ}_{0} = {S}_{0} .$$

Responsive to determining, at operation 320B, that the first coefficient λ₁ of the error locator polynomial is equal to zero, a decoding failure is returned at operation 322B; otherwise, at operation 324B, the only root of the error locator polynomial is computed as follows:

$${x}_{0} = {S}_{0} / {S}_{1} .$$

Accordingly, at operation 326B, the error magnitude is computed as follows:

$${E}_{0} = {S}_{0} .$$

The computed error magnitude can be used for restoring the original codeword, as described in more detail herein below.

As noted herein above, responsive to determining, at operation 316B, that the second coefficient λ₂ of the error locator polynomial is not equal to zero, the decoding flow branches to operation 328B.

Responsive to determining, at operation 328B, that the first coefficient λ₁ of the error locator polynomial is equal to zero, a decoding failure is returned at operation 330B; otherwise, at operation 332B, a quadratic equation is solved:

$${v}_{2} + v + d = 0 ,$$

$$where d = {λ}_{0} {λ}_{2} / {λ}_{1}^{2} = {λ}_{0} / {λ}_{1} {b}_{1} and b = {λ}_{1} / {λ}_{2} .$$

If no roots of the quadratic equation are found at operation 332B, a decoding failure is returned at operation 330B; otherwise, at operation 338B, two roots of the error locator polynomial are computed as follows:

$$\{ {x}_{0} , {x}_{1} \} = {b}_{1} \{ {v}_{0} , {v}_{1} \} ,$$

where {v₀, v₁} are the roots of the quadratic equation found at operation 332B.

Accordingly, at operation 340B, the error magnitudes are computed as follows:

$${E}_{0} = {v}_{0} {S}_{0} + {b}_{1} {S}_{1} d ; and$$

$${E}_{1} = {E}_{0} + {S}_{0} .$$

The error magnitudes (e.g., computed at operations 326B, 340B, or 364B) can be used for restoring the original codeword, as follows:

$$c ( x ) = r ( x ) + e ( x )$$

$$where e ( x ) = {\sum }_{ℓ = 0}^{s - 1} {e}_{{i}_{ℓ}} {x}^{{i}_{ℓ}} = {\sum }_{ℓ = 0}^{s - 1} {E}_{ℓ} {x}^{{i}_{ℓ}} ;$$

[symbol] = [symbol] denotes the corresponding non-zero error magnitude.

In some implementations, the formulas that are utilized for the above-described computations may be optimized for efficiency, such that the longest path of the flow would contain no more than a predefined number of division (inversion) operations, which are the most computationally complex arithmetic operations in finite fields. In particular, the longest path of the decoding flow 300A contains no more than three inversion operations: one inversion operation for computing the coefficient

$${λ}_{3}^{- 1}$$

which may be utilized for computing the coefficients c₀, c₁, and c_{2′}; one inversion operation for solving the cubic equation; and one inversion operation for computing the expression (y₁y₂)⁻¹, which may be utilized for computing the error magnitudes.

Similarly, the longest path of the decoding flow 300B contains no more than two inversion operations, for computing the coefficients b₁ and d.

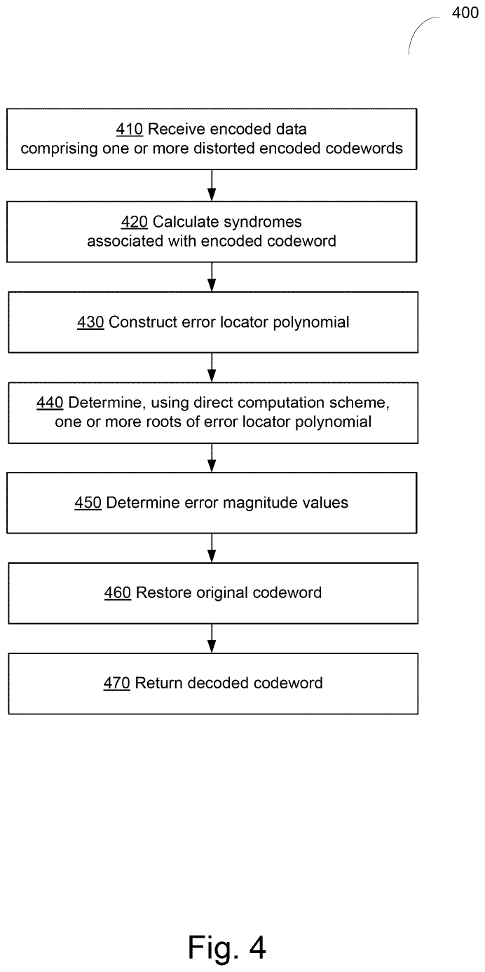

FIG. 4 is a high-level flow diagram of an example method 400 of decoding encoded codewords by a memory sub-system controller operating in accordance with aspects of the present disclosure. The method 400 may be performed by processing logic that may include hardware (e.g., general purpose or specialized processing devices, circuitry, dedicated logic, programmable logic, microcode, integrated circuits, etc.), software (e.g., instructions run or executed on a processing device), or various combinations thereof. In some implementations, method 400 may be performed by a single processing thread. Alternatively, method 400 may be performed by two or more processing threads, each thread executing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processing threads implementing method 400 may be executed asynchronously with respect to each other. In some implementations, the method 400 is performed by the memory system controller (e.g., ECC component 113 of FIG. 1) and/or local media controller. Operations of the method 400 may be specified by a sequence of command codes, which the processing logic may retrieve from a dedicated storage location. Although shown in a particular sequence or order, unless otherwise specified, the order of the operations may be modified. Thus, the illustrated implementations should be understood only as examples, and the illustrated operations may be performed in a different order, and some operations may be performed in parallel. Additionally, one or more operations may be omitted in various implementations. Thus, not all operations are required in every implementation.

At operation 410, the processing logic receives encoded data comprising one or more encoded codewords. In some implementations, the processing logic may read the encoded data from the memory device as part of a read operation by performing one or more sense operations to determine threshold voltage values of the memory cells that store the encoded data. In some instances, the sensed data read from the memory device may differ from the initial encoded data that was first generated, for example, on account of errors (e.g., bit-flip errors) that may have occurred during storage and/or retrieval of the encoded data to/from the memory device, and thus one or more sensed encoded codewords may be distorted. The sensed data, however, may be encoded using an ECC, such as an RS code, which may allow the processing logic to detect and correct errors in the sensed data and obtain initial host data encoded therein. For each encoded distorted codeword, the processing device may perform the decoding operations 420-460.

At operation 420, the processing logic calculates the syndromes associated with the received encoded codeword. Each syndrome is a value, at a predefined point, of a polynomial that is reconstructed from the received encoded codeword, as described in more detail herein above.

At operation 430, the processing logic constructs the error locator polynomial associated with the encoded codeword, as described in more detail herein above.

At operation 440, the processing logic determines, using a direct computational scheme (e.g., flow 300A of FIG. 3A or flow 300B of FIG. 3B), one or more roots of the error locator polynomial. In some implementations, the number of inversion operations implemented by the direct computational scheme is defined by the maximum number of correctable errors that can be comprised by the distorted encoded codeword. In an illustrative example, the distorted encoded codeword comprises no more than three correctable errors, and the longest path of the direct computational scheme comprises no more than three inversion operations. In an illustrative example, the distorted encoded codeword comprises no more than two correctable errors, and the longest path of the direct computational scheme comprises no more than two inversion operations, as described in more detail herein above.

At operation 450, the processing logic determines, using the one or more roots of the error locator polynomial, the error magnitude values associated with the encoded codeword, as described in more detail herein above.

At operation 460, the processing logic restores, using the error magnitude values, the original codeword corresponding to the distorted encoded codeword, as described in more detail herein above.

Responsive to successfully decoding the original codeword, the processing logic, at operation 470, returns the decoded codeword; otherwise, the processing logic may initiate the next error handing stage of the error handling sequence. Each error handling stage may include one or more read retries using different parameters, such as the read voltage, as compared to the previous read operation performed on the subset of memory cells. In some implementations, read voltage level adjustments may be performed based on the values of one or more data state metrics (e.g., RBER) obtained from a sequence of read and/or write operations.

In some implementations, at least some of the operations 420-460 may be performed by one or more hardware-based accelerators (e.g., implemented by one or more ASICs).

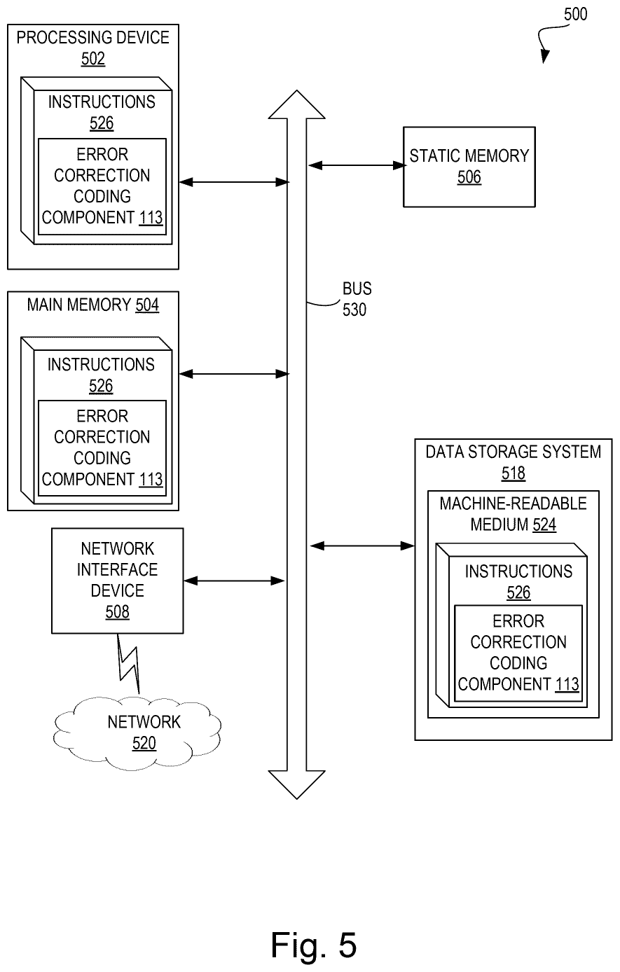

FIG. 5 illustrates an example machine of a computer system 500 within which a set of instructions, for causing the machine to perform any one or more of the methods discussed herein, may be executed. In some implementations, the computer system 500 may correspond to a host system (e.g., the host system 120 of FIG. 1) that includes, is coupled to, or utilizes a memory sub-system (e.g., the memory sub-system 110 of FIG. 1) or may be used to perform the operations of a controller (e.g., to execute an operating system to perform operations corresponding to the ECC component 113 of FIG. 1). In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methods discussed herein.

The example computer system 500 includes a processing device 502, a main memory 504 (e.g., read-only memory (ROM), flash memory, dynamic random access memory (DRAM) such as synchronous DRAM (SDRAM) or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device may be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 may further include a network interface device 508 to communicate over the network 520.

The data storage system 518 may include a machine-readable storage medium 524 (also known as a computer-readable medium) on which is stored one or more sets of instructions 526 or software embodying any one or more of the methods or functions described herein. The instructions 526 may also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 may correspond to the memory sub-system 110 of FIG. 1.

In one implementation, the instructions 526 include instructions to implement functionality corresponding to an error correction coding component (e.g., the ECC component 113 of FIG. 1). While the machine-readable storage medium 524 is shown in an example implementation to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methods of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure may refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus may be specially constructed for the intended purposes, or it may include a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct a more specialized apparatus to perform the method. The structure for a variety of these systems will appear as set forth in the description below. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). In some implementations, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A system, comprising:
a memory device; and
a processing device, operatively coupled to the memory device, the processing device to:
receive encoded data comprising a distorted encoded codeword;
calculate a plurality of syndromes associated with the distorted encoded codeword;
construct an error locator polynomial associated with the distorted encoded codeword;
determine, using a direct computational scheme, one or more roots of the error locator polynomial, wherein a number of inversion operations implemented by the direct computational scheme is defined by a maximum number of correctable errors;
determine, using the one or more roots of the error locator polynomial, one or more error magnitude values associated with the distorted encoded codeword; and
restore, using the one or more error magnitude values, an original codeword corresponding to the distorted encoded codeword.

2. The system of claim 1, wherein each syndrome of the plurality of syndromes is a value, at a predefined point, of a polynomial that is reconstructed from the distorted encoded codeword.

3. The system of claim 1, wherein the encoded codeword comprises at most three correctable errors, and wherein the direct computational scheme comprises at most three inversion operations.

4. The system of claim 1, wherein the distorted encoded codeword comprises at most two correctable errors, and wherein the direct computational scheme comprises at most two inversion operations.

5. The system of claim 1, wherein calculating the plurality of syndromes is performed by a hardware-based accelerator.

6. The system of claim 1, wherein constructing an error locator polynomial is performed by a hardware-based accelerator.

7. The system of claim 1, wherein determining the one or more roots of the error locator polynomial is performed by a hardware-based accelerator.

8. The system of claim 1, wherein determining the one or more error magnitude values is performed by a hardware-based accelerator.

9. The system of claim 1, wherein restoring the original codeword is performed by a hardware-based accelerator.

10. The system of claim 1, wherein receiving the distorted encoded codeword further comprises:
reading, at a current stage of a read error handling sequence, current stage data representing a subset of encoded data stored in a set of memory cells.

11. The system of claim 1, wherein the processing device is further to:
responsive to failing to restore the original codeword, perform a next stage of the read error handling sequence.

12. A method, comprising:
receiving, by a processing device, encoded data comprising a distorted encoded codeword;
calculating a plurality of syndromes associated with the distorted encoded codeword;
constructing an error locator polynomial associated with the distorted encoded codeword;
determining, using a direct computational scheme, one or more roots of the error locator polynomial, wherein a number of inversion operations implemented by the direct computational scheme is defined by a maximum number of correctable errors;
determining, using the one or more roots of the error locator polynomial, one or more error magnitude values associated with the distorted encoded codeword; and
restoring, using the one or more error magnitude values, an original codeword corresponding to the distorted encoded codeword.

13. The method of claim 12, wherein the distorted encoded codeword comprises at most three correctable errors, and wherein the direct computational scheme comprises at most three inversion operations.

14. The method of claim 12, wherein the distorted encoded codeword comprises at most two correctable errors, and wherein the direct computational scheme comprises at most two inversion operations.

15. The method of claim 12, wherein receiving the distorted encoded codeword further comprises:
reading, at a current stage of a read error handling sequence, current stage data representing a subset of encoded data stored in a set of memory cells.

16. The method of claim 12, further comprising:
responsive to failing to restore the original codeword, performing a next stage of the read error handling sequence.

17. A non-transitory computer-readable storage medium comprising instructions that, when executed by a processing device, cause the processing device to:
receive encoded data comprising a distorted encoded codeword;
calculate a plurality of syndromes associated with the distorted encoded codeword;
construct an error locator polynomial associated with the distorted encoded codeword;
determine, using a direct computational scheme, one or more roots of the error locator polynomial, wherein a number of inversion operations implemented by the direct computational scheme is defined by a maximum number of correctable errors;
determine, using the one or more roots of the error locator polynomial, one or more error magnitude values associated with the distorted encoded codeword; and
restore, using the one or more error magnitude values, an original codeword corresponding to the distorted encoded codeword.

18. The non-transitory computer-readable storage medium of claim 17, wherein the distorted encoded codeword comprises at most three correctable errors, and wherein the direct computational scheme comprises at most three inversion operations.

19. The non-transitory computer-readable storage medium of claim 17, wherein the distorted encoded codeword comprises at most two correctable errors, and wherein the direct computational scheme comprises at most two inversion operations.

20. The non-transitory computer-readable storage medium of claim 17, wherein receiving the distorted encoded codeword further comprises:
reading, at a current stage of a read error handling sequence, current stage data representing a subset of encoded data stored in a set of memory cells.
